(19) United States
(12) Patent Application Publication
(10) Pub. No.: US 2007/0194567 A1
(43) Pub. Date: Aug. 23, 2007

(54) Brake Tube Connector

(76) Inventor: Stanislav Pliassounov, Oakville (CA)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 11/623,556

(22) Filed: Jan. 16, 2007

Related U.S. Application Data
(60) Provisional application No. 60/775,082, filed on Feb. 20, 2006.

(51) Int. Cl. F16L 25/00; F16L 35/00

(52) U.S. Cl. 285/334.5; 285/384; 285/331

(57) ABSTRACT

A connector for sealing an elongated tube to a body comprises a seat having a spherical end portion wherein the connector body is adapted to receive the elongated tube to form a substantially rigid connection such that a flared end of the elongated tube may engage the spherical end portion of the seat to form a fluidic seal.

### FIELD OF THE INVENTION

The present invention relates to high pressure tube coupling arrangements. Moreover, the present invention relates to a threaded connector for a braking system that maintains a fluid-tight seal of the type used in a motor vehicle to actuate the braking system.

### BACKGROUND TO THE INVENTION

Hydraulic fluid systems are commonly used in motor vehicle braking systems. A supply of hydraulic braking fluid is provided in a master cylinder and, upon actuation of the brake pedal, applied at elevated pressure (i.e., 2000 psi) to individual wheel cylinders. In turn, wheel cylinders urge frictional surfaces into contact to generate a braking force. Therefore, several component interfaces exist in motor vehicle braking systems that must maintain a relatively high brake fluid pressure hydraulic pressure throughout the service of the braking system.

Threaded connectors are commonly used to attach brake tubing to the various braking system components in the manufacture of such braking systems. Such connectors typically include a nut having external threads situated over a flared tube end that is inserted into a mating threaded hole in the braking system component to which the tube is to be attached. Any leakage of the hydraulic brake fluid is unacceptable. Poor brake connector sealing robustness causes substantial repair labor and first run inhibition at the assembly plants.

Currently, the double inverted flare brake connector is defined by SAE J533 and JASO F402 standards. The shape of the double inverted flare is a cone frustum. The flare portion mates with the seat's frustum and creates the seal. A connector arranges the proper mutual positioning and clamping force between flare and seat. Good connector sealing may be expected only if adequate clamping force is developed onto the contact ring of sufficient size. There is a fundamental shortcoming of frustum to frustum mating. A ring of contact may be expected only if the axes of both the flare and the seat coincide. Otherwise, it is common that the result of cone/frustum side surfaces crossing (i.e., having a geometry entity which belongs to both frustums) is just a single point.

Typically a connector has some degree of robustness. A certain amount of self-adjustment or reasonable sustained deformation is expected in order to correct the mutual positions of the components toward development of a ring like contact area between the flare and the seat. However, under certain conditions, and in current state of the art frustum-to-frustum connectors, friction may lock the flare in a misaligned state against the seat in a position where sealing can not occur. This locked misalignment inhibits self-adjustment as mutual motion of the components gets restricted. Reasonable torque increases may not be sufficient to provide the deformation required to develop the seal in that situation. Furthermore, torque increases can squash joint components and preclude development of the seal.

It is also important to acknowledge the fundamental difference between two different examples of intersections between two geometrical bodies: cone-to-torus and sphere-to-cone. Currently, a cone seat always has a radius at its small frustum's diameter. In other words, there is a portion of which is a torus surface, not a sharp edge. The type of curvature which is provided by a torus is not sufficient to support the desired performance (guaranteed presence of a ring shaped line of initial contact). A torus crosses a cone by a circle only in one particular situation: when the axes align or coincide. This is similar in the case of a cone-to-cone intersection.

Therefore, what is needed is an improved design which will avoid locked misalignment. Such a design might use geometrical shapes that allow the initial flare-to-seat contact to always occur on a ring (not a single point) even when the axes are misaligned.

### SUMMARY OF THE INVENTION

According to a first aspect of the present invention, a fluidic connector body comprises a seat having a spherical end portion wherein the connector body is adapted to receive an elongated tube to form a substantially rigid connection such that a flared end of the elongated tube may engage the spherical end portion of the seat to form a fluidic seal.

According to a second aspect of the invention, a fluidic connector assembly comprises a connector body having a seat with a spherical end portion, an elongated tube having a flared end, and a nut. The connector body is adapted to receive the elongated tube and the nut to form a substantially rigid connection and both the flared end of the tube and the spherical end portion of the seat are engaged so as to form a fluidic seal therebetween.

One advantage of the present invention is incorporation of a portion of a sphere into the seat's shape. In the presence of reasonable angular misalignment, the initial flare to seat contact will occur always on a ring due to the fundamental geometrical properties of both cones and spheres.

A cross-section of the interface between a cone and a sphere results in a circumference. A sphere will result in a circle of contact with a cone even if the axes are not coincided. It is the usage of a spherical shape which provides new functionality. A sphere is better in respect to providing robust sealing because a circle is the only possible shape of initial contact in this case. It is easier to develop good sealing starting from a circle than from a single point.

According to a further aspect of the invention, a method for forming a substantially-rigid fluidic connection. The method comprises the steps of first, providing a connector body having a seat with a spherical end portion. The next step comprises inserting an elongated tube having a flared end portion into the connector body. The next step comprises aligning the tube in relation to the fluidic connector within an annular range. The next step comprises inserting a nut into the connector body so as to forcibly engage the flared end of the elongated tube to the spherical end portion of the seat so as to form a fluidic seal.

One advantage of the present invention is the spherical portion of the seat has sufficient size to accommodate the required amount of misalignment. The angular size of the portion of a sphere is greater than the expected degree of angular misalignment.

A further advantage of the present invention is the spherical shape of the seat. In the event of a lateral misalignment, the spherical shape of the seat provides better conditions for self-adjustment than the prior art cone shape does.

Another advantage of the present invention is virtual elimination of initial contact by any of the flare's edges due to the curvature of the seat's sphere shape. Thus, locked misalignment of such a connector is greatly reduced or eliminated. A lateral misalignment shall be corrected by self-adjustment (i.e., sliding of the flare across the seat) while securing this connector.

### BRIEF DESCRIPTION OF THE DRAWINGS

By way of example only, embodiments of the present invention will now be described with reference to the accompanying drawings wherein:

FIG. 1 is a perspective view of an embodiment of a connector of the present invention.

FIG. 2 is a cross sectional view of an embodiment of a connector of the present invention in its assembled condition.

### DETAILED DESCRIPTION OF PREFERRED EMBODIMENTS OF THE INVENTION

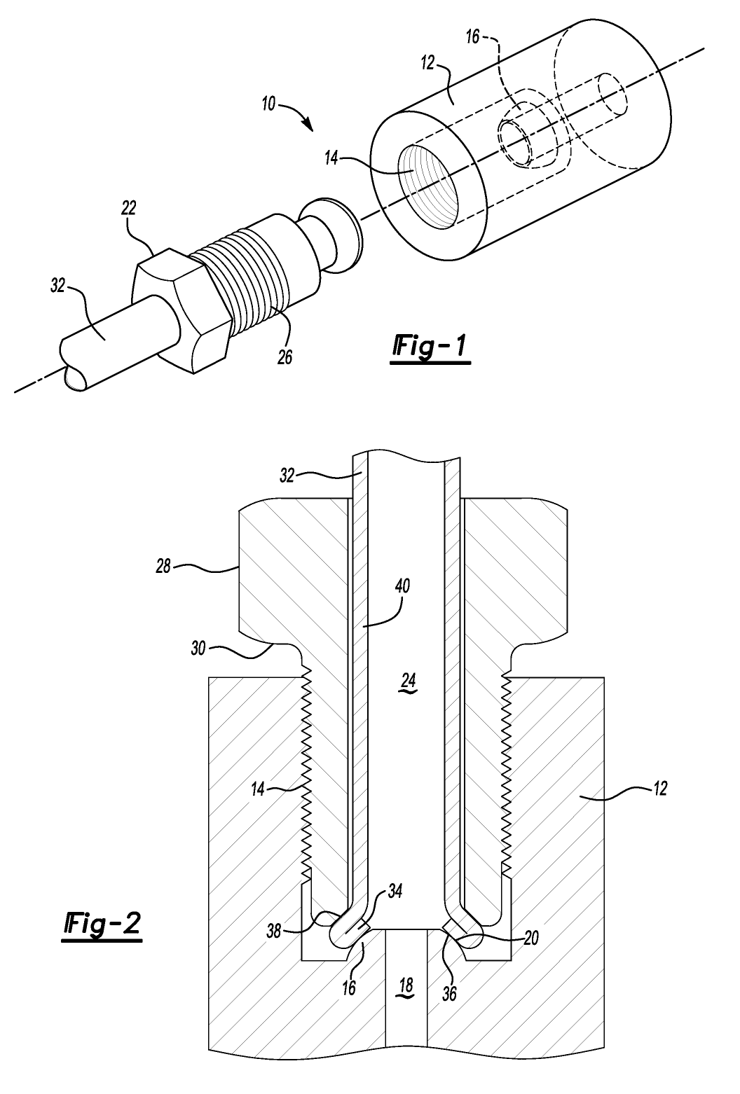

Referring now to FIG. 1, there is shown a connector assembly 10 made in accordance with the teachings of the preferred embodiment of the invention to be used in a motor vehicle (not shown). The connector assembly 10 is a fluidic joint that provides robust communication between a fluid source, such as a hydraulic control unit, and a device, such as a brake caliper. The connector assembly 10 comprises a connector body 12, a nut 22, and an elongated tube 32.

Referring now to FIGS. 1 and 2, the connector body 12 comprises a threaded bore 14, a seat 16, and a passageway 18. The threaded bore 14 is a female portion of the connector assembly 10 and is internally threaded so as to receive the nut 22. The seat 16 comprises a spherical end portion 20 adapted to be in sealing contact with the elongated tube 32. The passageway 18 is adapted to allow the passage of a fluid through the connector body 12. The threaded bore 14, seat 16, and passageway 18 are preferably concentrically aligned such that they share a common central axis, however may be aligned in another manner. The connector body 12 is preferably a single piece composed of a homogenous metal material. Alternatively, the connector body 12 may comprise multiple pieces or be composed of a non-metal material, either partially or entirely. The connector body 12 may be integrally formed with a fluid source or device, or could also be couple to the fluid source or device by another method, whether fixed or removable. Alternatively, the connector body 12 may be used in a similar application such as connecting multiple conduits or branching a single fluid source to multiple destinations.

The elongated tube 32 comprises a flared end 34, having an interior face 36, an exterior face 38, and a tube body 40. The flared end 34 substantially forms a portion of a cone, defined by the interior face 36 and the exterior face 38. The flared end 34 is disposed at one end of the elongated tube 32. Preferably the flared end 34 is formed integrally with tube body 40, however may be coupled in another manner, such as through welding or mating threads. The elongated tube 32 is preferably a brake tube of a known type, however it can be of any type or material, homogeneous or otherwise, sufficient for use in automotive braking applications or in any other similar application.

The nut 22 of preferable design comprises a central bore 24, a threaded exterior portion 26, a head portion 28, and an abutting face 30. The central bore 24 forms the shape of a cylinder and passes entirely through the nut 22. The threaded exterior portion 26 and central bore 24 are concentric, sharing a common central axis. The head portion 28 is disposed at one end of the nut 22 and is adapted to be driven by a fastening tool. The abutting face 30 is disposed at the end opposite the head portion 28. The nut 22 is preferably composed of a homogenous metallic material, however may be composed of multiple pieces or of another material, such as plastic.

The connector body 12 is adapted to receive the elongated tube 32 such that the spherical end portion 20 of the seat 16 and the interior face 36 of the flared end 34 are engaged in a sealing relationship. Assuming axial alignment of the tube body 40 and the passageway 18, the interaction defined by the conical shape of the interior face 36 and the spherical shape of the seat 16 provides for circumscribing (ring-shaped) contact through a range of annular alignment, thereby limiting leak paths. Furthermore, in contrast to the prior art, when axial alignment is not achieved, the present invention is able to still achieve a sealing relationship.

The nut 22 functions to hold the flared end 34 in sealing relationship with the seat 16. The body 40 of the elongated tube 32 passes through the central bore 24 of the nut 22 so that the abutting face 30 is located proximate to the exterior face 38 of the flared end 34. The threaded bore 14 of the connector body 12 is adapted to receive the threaded exterior portion 26 of the nut 22, and the head portion 28 of the nut 22 is utilized to drive the nut 22 into the connector body 12. With the threads of the connector body 12 and the nut 22 engaged, the abutting face 30 is force into contact with the exterior face 38 of the flared end 34, thereby forcibly engaging the interior face 34 into sealing contact with the spherical end portion 20 of the seat 16. Thereby, a robust connection for fluidic communication between a fluid source and a destination is provided through the body 40 of the elongated tube 32 and the passageway 18 of the connector body 12.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

1. A fluidic connector body, comprising: a seat having a spherical end portion, wherein the connector body is adapted to receive an elongated tube to form a substantially rigid connection and such that a flared end of the elongated tube may engage the spherical end portion of the seat to form a fluidic seal.

2. The fluidic connector body of claim 1, wherein the flared end of the elongated tube may define a portion of a cone having an interior face and an exterior face, wherein the interior face may contact the spherical end portion of the seat to form the fluidic seal.

3. The fluidic connector body of claim 1 further adapted to receive a nut, wherein the nut may forcibly engage the flared end of the elongated tube to the spherical end portion of the connector body.

4. The fluidic connector body of claim 2 further adapted to receive a nut, wherein the nut may forcibly engage the flared end of the elongated tube to the spherical end portion of the connector body.

5. The fluidic connector body of claim 1 further adapted to be coupled to a device.

6. The fluidic connector body of claim 4 further adapted to be coupled to a device.

7. The fluidic connector body of claim 1, wherein the elongated tube may be a brake tube.

8. The fluidic connector body of claim 6, wherein the elongated tube may be a brake tube.

9. A fluidic connector assembly, comprising: a connector body having a seat with a spherical end portion, an elongated tube having a flared end, and a nut, wherein the connector body is adapted to receive the elongated tube and the nut to form a substantially rigid connection and the flared end of the tube and the spherical end portion of the seat are engaged so as to form a fluidic seal therebetween.

10. The fluidic connector assembly claim 9, wherein the flared end of the elongated tube defines a portion of a cone having an interior face and an exterior face, wherein the interior face contacts the spherical end portion of the seat.

11. The fluidic connector assembly claim 9, wherein the connector body further comprises a threaded bore and the nut comprises a central bore and a threaded exterior portion, wherein the threaded bore of the connector body is adapted to receive the threaded exterior portion of the nut, the central bore of the nut is adapted to receive the elongated tube, and the nut is further adapted to forcibly engage the flared end of the elongated tube to the spherical end portion of the seat.

12. The fluidic connector assembly claim 10, wherein the connector body further comprises a threaded bore and the nut comprises a central bore, a threaded exterior portion, a head portion, and an abutting face, wherein the threaded bore of the connector body is adapted to receive the threaded exterior portion of the nut, the central bore of the nut is adapted to receive the elongated tube, and the abutting face of the nut is adapted to engage the exterior face of the flared end of the elongated tube.

13. The fluidic connector assembly claim 9, wherein the connector body forms a portion of a device.

14. The fluidic connector assembly claim 12, wherein the connector body forms a portion of a device.

15. The fluidic connector assembly claim 9, wherein the elongated tube is a brake tube.

16. The fluidic connector assembly claim 14, wherein the elongated tube is a brake tube.

17. A method for forming a substantially-rigid fluidic connection, comprising the steps of:
Providing a connector body having a seat with a spherical end portion,
Inserting an elongated tube having a flared end portion into the connector body,
Aligning the tube in relation to the fluidic connector within an annular range,
And inserting a nut into the connector body so as to forcibly engage the flared end of the elongated tube to the spherical end portion of the seat so as to form a fluidic seal.
